(19) United States
(12) Patent Application Publication
(10) Pub. No.: US 2025/0314560 A1
(43) Pub. Date: Oct. 9, 2025

(54) VAPING LIQUID EXTRACTION DEVICES

(71) Applicant: GenTech Solutions LLC, Irvine, CA (US)

(72) Inventors: Harit Kaushikbhai Patel, Lake Forest, CA (US); John Shepler, Laguna Hills, CA (US)

(21) Appl. No.: 18/629,223

(22) Filed: Apr. 8, 2024

(51) Int. Cl. G01N 1/10; A24F 40/10; A24F 40/42; A24F 40/80

(52) U.S. Cl. CPC G01N 1/10; A24F 40/10; A24F 40/42; A24F 40/80; G01N 2001/1037

(57) ABSTRACT

Embodiments of the inventive subject matter are directed to vaping liquid extraction devices that make it possible to extract vaping liquid from vaping cartridges by using a centrifuge. Vaping liquid extraction devices are designed to be placed into test tubes such that vaping cartridges can be held inside extraction devices and suspended within the test tubes. Test tubes can then be run through a centrifuge to cause vaping liquid to come out of the vaping cartridges so that the vaping liquid can be tested. Vaping liquid otherwise could not be easily extracted from vaping cartridges due to high viscosity of the liquids relative to the size of the holes in vaping cartridges that are designed for air/vapor to pass through.

### FIELD OF THE INVENTION

The field of the invention is devices to facilitate extracting vaping liquid from vaping cartridges.

### BACKGROUND

The background description includes information that may be useful in understanding the present invention. It is not an admission that any of the information provided in this application is prior art or relevant to the presently claimed invention, or that any publication specifically or implicitly referenced is prior art.

Vaping liquids can be made to include a variety of different chemicals, including THC, nicotine, and others. For example, concentrated forms of cannabis that can be used for various purposes, such as medical treatment, recreational use, or industrial applications can be heated to vaporization temperatures that enable inhalation. Among these, cannabis oils stand out as a concentrated derivative extracted from cannabis plant material, prized for its versatile utility. Cannabis oil can be extracted from cannabis plant material using various methods, such as solvent extraction, supercritical fluid extraction, or mechanical separation. One of the properties that affects the quality and usability of cannabis oil is its viscosity, which is a measure of how easily the oil flows. A defining characteristic of cannabis oils that significantly influences its efficacy and desirability is its viscosity, denoting the resistance of a fluid to flow, holds paramount importance in determining the handling, storage, and dispensing characteristics of cannabis oil. Typically, cannabis oils are highly viscous, and they are contained in disposable cartridges having a small diameter hole that allows for air to enter the cartridge while vapor is pulled out of a mouthpiece.

As more states legalize cannabis sales and consumption, a need for regulation, testing, and safety standards has arisen. States like California have placed new testing requirements for commercialized sales of cannabis and cannabis infused products, including new requirements around THC potency and packing, including regulations relating to exchangeable vaping cartridges. These regulatory frameworks extend far beyond mere legalization; they encompass comprehensive testing protocols aimed at safeguarding public health. In the realm of cannabis and cannabis-infused products, including vaping liquids, meticulous testing is mandated to ascertain factors such as THC potency, cannabinoid profile, and the absence of contaminants such as pesticides, heavy metals, and microbial agents. These standards are designed to protect consumers from potential health hazards while also fostering trust and confidence in the burgeoning cannabis industry.

The high viscosity of vaping liquids can pose challenges for storing, transporting, and dispensing those liquids (such as cannabis oil), especially in liquid form. For example, exchangeable cannabis oil cartridges are commonly used to attach to vaporizers or electronic cigarettes, which allow the user to inhale the vaporized oil. These cartridges are screwed onto a battery that superheats the inside of the cartridge for the user to then inhale vaporized oil. Cartridges are typically made out of glass and are completely sealed and glued to associated metal components, and one these cartridges are empty, they are typically thrown away. California has recently mandated that oil in these cartridges must be analyzed after it has been packaged and sealed. But sealing these cartridges for sale make it extremely difficult to extract oil for testing—the oil is highly viscous and holes on the cartridge are designed for air/vapor flow, not viscous oil flow. Lab technicians trying to extract fluid for testing thus have to pry the cartridges apart, which can cause the glass to break.

With this new testing requirement comes a need for a way to extract some amount of oil from these cartridges. But high viscosity oils combined with very small diameter holes intended to vapor flow present significant challenges. A need in the art therefore exists for systems and methods that facilitate extraction of high viscosity fluids from vaping cartridges without a risk of breaking those cartridges.

### SUMMARY OF THE INVENTION

The present invention provides apparatuses, systems, and methods directed to extracting vaping liquid contained within vaping cartridges. In one aspect of the inventive subject matter, a vaping liquid extraction device is contemplated, comprising: a first opening at a top portion of an interior space; a hole at a bottom portion of the interior space; and a lip coupled with the opening at the top portion, where the lip extends outward from the top portion and where the hole is smaller than the first opening.

In some embodiments, the lip has a circular outer edge. The interior space can have a second minimum wall-to-wall distance that is the same as the minimum wall-to-wall distance of the opening. The interior space should be elongated to accommodate a vaping cartridge. In some embodiments, the first opening at the top portion has a minimum wall-to-wall distance of between 8 mm and 20 mm. The hole can have a diameter of between 0.5 mm and 5 mm.

In another aspect of the inventive subject matter, a vaping liquid extraction device is contemplated, comprising: a first top opening and a second top opening at a top portion of an interior space, where the interior space comprises a first section and a second section, the first section leading to the first top opening and the second section leading to the second top opening; a lip coupled with the top portion of the interior space, where the lip extends outward from the top portion; a first hole at a bottom of the first section; and a second hole at a bottom of the second section, where the first hole is smaller than the first top opening, and where the second hole is smaller than the second top opening.

In some embodiments, the lip comprises a circular outer edge, and the first section and the second section are at least partially joined to form the interior space. The first section and the second section should be elongated to accommodate vaping cartridges. In some embodiments, the first top opening and the second top opening each have a minimum wall-to-wall distance of between 8 mm and 20 mm, and the first hole and the second hole each have a diameter of between 0.5 mm and 5 mm.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows a vaping liquid extraction device.

FIG. 2 shows a vaping liquid extraction device from another angle.

FIG. 3 shows a vaping cartridge.

FIG. 4 shows a vaping cartridge placed into a vaping liquid extraction device that is in a test tube.

FIG. 5 shows a vaping cartridge in a vaping liquid extraction device that is in a test tube and ready to be placed in a centrifuge.

FIG. 6 shows a centrifuge loaded with test tubes.

FIG. 7 shows a test tube with vaping liquid in it after being run through a centrifuge with a cartridge and vaping liquid extraction device.

FIG. 8 shows an alternative embodiment that can accommodate three vaping cartridges.

FIG. 9 shows another view of the alternate embodiment in FIG. 8.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

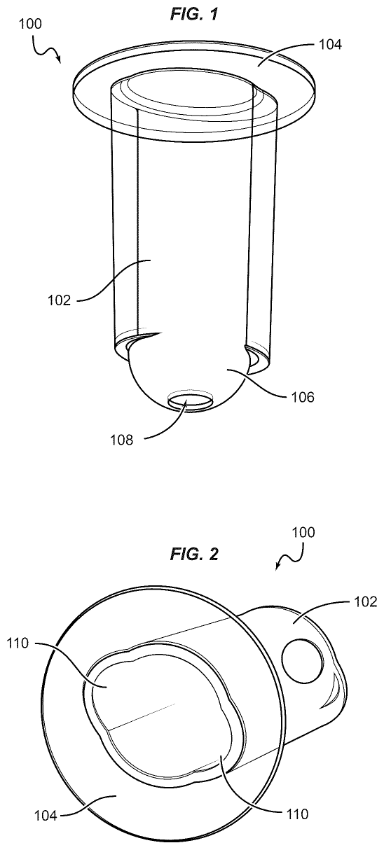

FIGS. 1 and 2 show a vaping liquid extraction device of the inventive subject matter. Vaping liquid extraction devices are meticulously designed to nest seamlessly inside a test tube, facilitating subsequent placement within a centrifuge for extraction purposes. Central to their functionality is the efficient extraction of vaping liquids while ensuring the integrity of both the cartridges and the extracted liquid. Vaping liquid extraction devices thus facilitate extraction of highly viscous vaping liquids (e.g., cannabis oils) from vaping cartridges. Vaping liquid extraction device 100 features a body 102, a lip 104, an extraction end 106, and a hole 108 disposed on extraction end 106.

Lip 104 is flared outward from body 102. Lip 104 is typically a flat portion that is sized and dimensioned to interact with the top portion of an open test tube. When vaping liquid extraction device 100 is placed in a test tube, lip 104 prevents it from falling down into the test tube and suspends extraction end 106 above the bottom of the test tube. In test tubes that have a cap, lip 104 sits between an upper edge of the test tube and the test tube's cap. Upon screwing the cap to the test tube, the lip that is sandwiched therebetween can facilitate creating an air or fluid tight seal. Lip 104 is shown as a circular component in the figures, though it can be formed to take on other shapes as needed.

Body 102 thus creates an interior space that can accommodate a vaping cartridge. The interior space of some embodiments must be long enough to fit a vaping cartridge in its entirety within the interior space (e.g., so that a test tube cap can screw onto the test tube that the caping liquid extraction device is placed in). In some embodiments, a test tube does not have a cap or does not otherwise need a cap to be screwed onto its top, and in such cases, the interior space does not need to be so elongated as to accommodate an entire vaping cartridge. In such cases, some portion of the vaping cartridge can stick out of the vaping liquid extraction device. It is at least preferable that a center of mass of a vaping cartridge is inside the interior space of a vaping liquid extraction device when the vaping cartridge is placed therein.

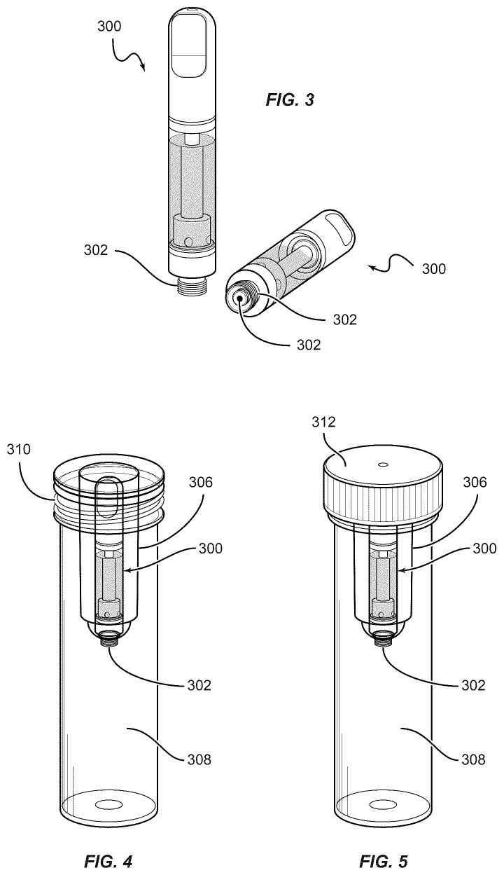

In some embodiments, body 102 has an inner diameter that ranges from 8 mm to 20 mm, where the inner diameter can be sized and dimensioned based on the outer diameter of different vaping cartridges. For example, some standard cartridge diameters are 12 mm and 14 mm. Thus, the inner diameter of body 102 would need to be greater than either 12 mm or 14 mm such that either sized cartridge can easily slide in and back out of body 102. Although vaping cartridges typically have diameters between 8 and 22 mm, larger and smaller cartridges can be accommodated without deviating from the inventive subject matter. Hole 108 is also sized and dimensioned according to a structural component of different vaping cartridges, as discussed below regarding FIG. 3.

Although diameters are described above regarding both the interior space and hole 108, it should be understood that all diameter measurements can also be interpreted as describing a minimum width, or minimum wall-to-wall distance. For example, a vaping liquid extraction device can be said to have a top opening that has a diameter of 15 mm. In embodiments where the interior space formed into the body is cylindrical, then describing a diameter is intuitive. In embodiments where the interior space is not cylindrical (e.g., it does not have circular cross-sections), then the term diameter should be understood to disclose a minimum distance from one wall to an opposite wall of the interior space, which ensures that vaping cartridges having diameters less than the minimum wall to wall distance can fit in the interior space.

As shown in FIG. 2, the hole into which a cartridge is placed includes bulges 110 on opposite sides. Bulges 110 can be useful to make it easier to remove cartridges using, e.g., tweezers. Bulges 110 can also make it easier to place cartridges into a vaping liquid extraction device by creating a wider portion that makes it easier to align the cartridge with the opening.

Vaping liquid extraction devices of the inventive subject matter can be formed, e.g., by extrusion, by joining a plurality of molded components together using heat, and the like. If made by extrusion, a piece of plastic stock can be placed over a mold, heated, and then an interior space of the device can formed by pressing a complementary molding component against the plastic and into the molding hole. A hole can then be drilled into the end of the device to let a vaping cartridge's threaded end pass therethrough.

Vaping cartridge 300 is shown in FIG. 3, and it is representative of different vaping cartridges that can be used with embodiments of the inventive subject matter. Vaping cartridge 300 includes a threaded end 302. Threaded end 302 has an air hole 304 at one end that allows air to be pulled through the cartridge such that vaporized liquid can be inhaled. Ordinarily, air hole 304 (and the hole on the other end of the cartridge that a user puts their mouth around) is large enough for air and vapor to pass through, but too small for any of the vaping liquid of a cartridge to pass through (e.g., cannabis oil or other byproducts, tobacco oils or other byproducts, e-liquid, and so on). Air hole 304 on threaded end 302 can be, e.g., 0.7 mm, 1.0 mm, 1.5 mm, 2.0 mm, or any diameter therebetween, and threaded end 302 should fit through hole 108, which is designed specifically such that threaded end 302 can pass through it. In some embodiments, air hole 304 diameter can be any value between (or including) 0.5 mm and 5 mm.

FIG. 4 shows cartridge 300 inside a vaping liquid extraction device 306, with vaping liquid extraction device 306 set into a test tube 308. Threaded end 302 is shown extending through the hole at the bottom of vaping liquid extraction device 306 so that vaping liquid contained in cartridge 300 can be forced out of the air hole at the end of the threaded end and into test tube 308. Lip 104 rests atop the upper edge of test tube 308 so that the test tube's cap (312 as seen in FIG. 5) can be screwed down using threads 310. Upon screwing on a cap, the vaping liquid extraction device is held in place within the test tube, and cartridge 300 is held in place therein. FIG. 5 shows test tube 308 with cap 312 screwed on top and cartridge 300 held in place within vaping liquid extraction device 306. Once everything is assembled according to FIG. 5, it can be placed into a centrifuge.

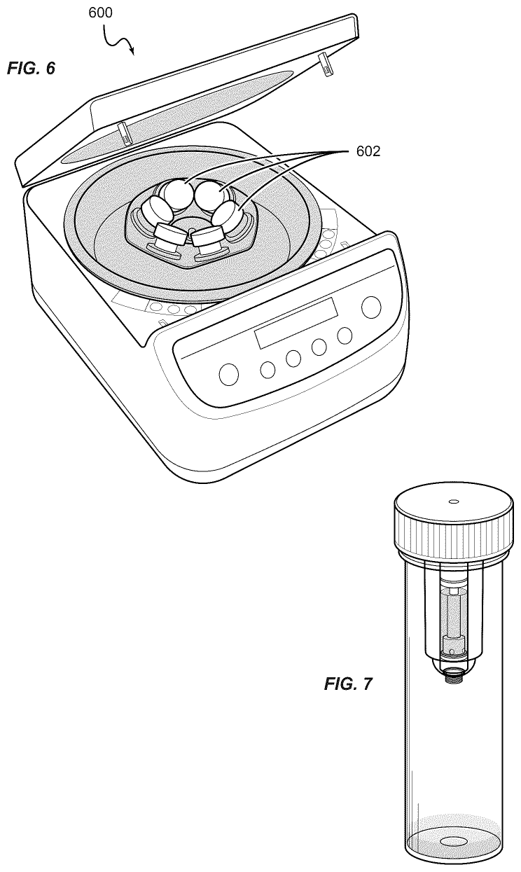

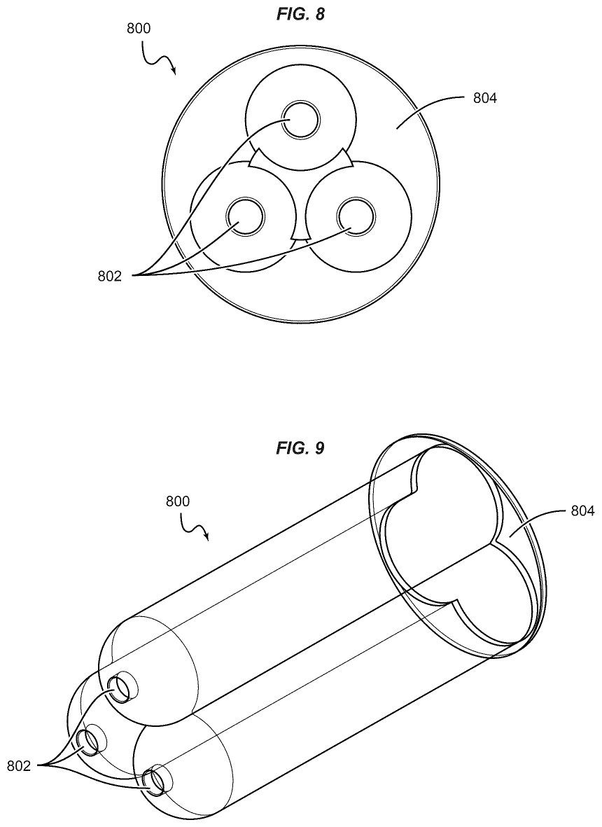

FIG. 6 shows a centrifuge 600 with test tubes 602 placed therein. By activating the centrifuge 600, cartridges are held in place by vaping liquid extraction devices that are placed in each of the test tubes 602, and vaping liquid inside the cartridges is forced out of the air holes on those cartridges by centrifugal forces. Vaping liquid forced out of the cartridges is captured in test tubes 602, and, once extracted, vaping liquids in test tubes 602 can be easily extracted from those test tubes to, e.g., undergo testing. FIG. 7 shows a test tube after it has been spun in the centrifuge with contents from a cartridge at the bottom.

Vaping liquid extraction devices of the inventive subject matter can be made from a variety of materials, including plastics, metals, and composites. Transparent plastics are preferable to make it easier to align the threaded end of a cartridge with the hole at an end of the vaping liquid extraction device that the cartridge is inserted into. In general, plastics are sufficiently strong to hold cartridges in place while a centrifuge rotates.

To force vaping liquid out of the air hole, a centrifuge should rotate between (or including) 500 and 6000 RPM. Centrifuge rotation speed can depend on several factors, including vaping liquid viscosity, air hole size on a particular cartridge, density of the oil, and so on. As described above, the air hole in a cartridge through which vaping liquid must pass can have a diameter ranging from 0.5 mm to 5 mm. Ordinarily, vaping liquid cannot easily pass through cartridge air holes, which is a necessary feature to ensure vaping liquid does not spill out. But because vaping liquid testing can be necessary in some instances (e.g., in certain states or jurisdictions), using a centrifuge as described in this application can force vaping liquid out of vaping cartridges to facilitate vaping liquid testing.

FIGS. 8 and 9 show a vaping liquid extraction device 800 that can accommodate three cartridges at once. FIG. 8 is a view looking down into the top of vaping liquid extraction device 800. From this perspective, three holes 802 are visible at the bottom. These holes are configured the same as the hole described above. They are sized and dimensioned so that the threaded ends of vaping cartridges can pass through them. Vaping liquid extraction device 800 similarly features lip 804 that rests on the top edge of a test tube into which vaping liquid extraction device 800 is placed. When a test tube cap is screwed down onto the top of the test tube, lip 804 is sandwiched between the test tube and the cap, exactly as described above.

Interior spaces for each of three vaping cartridges that can be placed in vaping liquid extraction device 800 are partially joined. In other words, there is only partial physical separation between each of the three interior spaces—13 each of the interior spaces is formed as a cylinder where the overlapping portions of the three cylinders are open to join the interior spaces.

Thus, specific systems and methods of extracting the contents of vaping cartridges have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A vaping liquid extraction device, comprising:
a first opening at a top portion of an interior space;
a hole at a bottom portion of the interior space;
a lip coupled with the opening at the top portion, wherein the lip extends outward from the top portion;
wherein the hole is smaller than the first opening.

2. The device of claim 1, wherein the lip comprises a circular outer edge.

3. The device of claim 1, wherein the interior space has a second minimum wall-to-wall distance that is the same as the minimum wall-to-wall distance of the opening.

4. The device of claim 1, wherein the interior space is elongated to accommodate a vaping cartridge.

5. The device of claim 1, wherein the first opening at the top portion has a minimum wall-to-wall distance of between 8 mm and 20 mm.

6. The device of claim 1, wherein the hole has a diameter of between 0.5 mm and 5 mm.

7. A vaping liquid extraction device, comprising:
a first top opening and a second top opening at a top portion of an interior space;
wherein the interior space comprises a first section and a second section, the first section leading to the first top opening and the second section leading to the second top opening;
a lip coupled with the top portion of the interior space, wherein the lip extends outward from the top portion;
a first hole at a bottom of the first section;
a second hole at a bottom of the second section;
wherein the first hole is smaller than the first top opening; and
wherein the second hole is smaller than the second top opening.

8. The device of claim 7, wherein the lip comprises a circular outer edge.

9. The device of claim 7, wherein the first section and the second section are at least partially joined to form the interior space.

10. The device of claim 7, wherein the first section and the second section are elongated to accommodate vaping cartridges.

11. The device of claim 7, wherein the first top opening and the second top opening each have a minimum wall-to-wall distance of between 8 mm and 20 mm.

12. The device of claim 7, wherein the first hole and the second hole each have a diameter of between 0.5 mm and 5 mm.
